(19) United States
(12) Patent Application Publication
(10) Pub. No.: US 2004/0239060 A1
(43) Pub. Date: Dec. 2, 2004

(54) Steerable person handling system

(76) Inventors: Martin Faucher, Kateville (CA); Michel Corriveau, Eaton (CA)

Correspondence Address: BROUILLETTE KOSIE, 25th Floor, 1100 Rene-Levesque Boulevard West, Montreal, QC, H3B 5C9, CA

(21) Appl. No.: 10/445,359

(22) Filed: May 27, 2003

(51) Int. Cl. B62B 3/00

(52) U.S. Cl. 280/47.11

(57) ABSTRACT

A system (i.e. apparatus, combination, etc.) for use in the transportation of a person (e.g. patient, handicapped person, invalid, etc.) from one location to another. The system may in particular be a steerable person handling system wherein the manoeuvrability thereof is facilitated by a steering mechanism wherein one forward swivelable castor wheel and one rear swivelable castor wheel, which are on opposite sides of the system, are connected or coupled together with a steering control component such that the steering control component may induce a controlled and simultaneous swivelling of these steerable castor wheels in opposite directions.

The present invention relates to a system (i.e. apparatus, combination, etc.) for use in the transportation of a person (e.g. patient, handicapped person, invalid, etc.) from one location to another. The present invention in particular relates to steerable person handling system wherein the manoeuvrability thereof is facilitated by a steering mechanism wherein one forward swivelable castor wheel and one rear swivelable castor wheel, which are on opposite sides of the system, are connected or coupled together with a steering control component such that the steering control component may induce a controlled and simultaneous swivelling of these steerable castor wheels in opposite directions.

It is to be understood that the expression “wheel assembly” refers to a wheel construct comprising a wheel and a rotational connection component for connecting the wheel to a person support structure (e.g. the leg of a chair, etc.); the wheel and the rotational connection component being configured in any suitable (known) manner such that the wheel is able to rotate or turn about it's circumference so as to be able to rollover a (support) surface, i.e. for rolling motion. The wheel may take any known form such as for example a disc shape, a ball like shape etc. In the case of a disc like shape the rotational connection component may connect the wheel to a person support structure such that the wheel may rotate about a rolling axis, which is substantially horizontal (when the wheel is in motion or in use).

It is to be understood herein the words castor(s), castor means, castor wheel assembly and the like refer to wheel constructs in which a wheel is supported not only for rolling motion as mentioned above, but also for swivelling movement about a swivel axis; the swivel axis being an axis which is substantially vertically oriented (when in use); the swivel axis may for example traverse the above mentioned rolling axis or, if so desired, be offset from the rolling axis of a disc shaped wheel.

Thus it is further in particular to be understood herein that the expression “castor wheel assembly” refers to an assembly comprising in addition to a wheel, a rotational connection component; the wheel and the rotational connection component being configured in any suitable (known) manner whereby the wheel may be connected to a load support (e.g. patient support means) such that the wheel is able to swivel about a respective vertically extending axis; in other words, the wheel in this case is a swivel wheel. Castor wheel assemblies are known; see for example U.S. Pat. Nos. 2,388,692 and 4,248,444.

It is also to be understood herein the entire contents of each and every patent document mentioned herein is incoporated herein by reference.

Various type of person (e.g. patient) transport or handling devices are known; see for example U.S. Pat. Nos. 5,185,895, 5,333,333, 5,379,468 and 5,388,2898. Once a patient is installed on a transport device a substantial effort is needed on the part of the person moving a patient in order to move the transport device around a small space, e.g. to transfer a patient from a bed to a bathing or wash area; this is especially so if the patient is heavy set. However, it is often difficult to control such devices whether during straight line movement, manoeuvring around obstacles, or when negotiating turns.

Devices are known which attempt to deal with the steering problems associated with respect to small carts, wheeled platforms and the like; see for example U.S. Pat. Nos. 2,388,692, 4,934,726 and 4,950,126 as well as published Canadian patent application no. 2,093,121.

U.S. Pat. No. 4,248,444 (the entire contents of which is incoporated herein by reference) for example shows a steering mechanism for a hospital type carriage wherein a front swivelled castor and a rear swivelled castor on the same side of the carriage are coupled or connected together for inducing simultaneous rotation thereof in respective opposite directions. However, motion in any particular direction is accomplished by an operator having to expend a significant effort in order to physically push the carriage in the desired line or direction of motion. The connection of the swivelled casters is accomplished by a system of chains and intermediate sprockets.

However, a need still exist for a manouverable patient handling apparatus.

It would in particular be advantageous to have a steerable patient handling apparatus which has a mechanism or means for facilitating steering thereof.

The entire contents of each of the patents mentioned herein is incorporated herein by reference.

### STATEMENT OF INVENTION

In accordance with the present invention, it has been determined that the manoeuverability of a person handling system (e.g. device) is facilitated (e.g. relatively enhanced) by coupling a front castor on one side of the system with a rear castor on the other side of the system so as to form a (single) steerable pair of castors. The opposed (i.e. crisscross) castor coupling permits the system to be relatively easily swung through an arc or to be displaced laterally when a specified force is for example manually applied to position the system as desired.

Thus in one aspect the present invention provides a steerable mobile system (i.e. apparatus, combination, etc.) for the transportation of a person (e.g. patient, handicapped person, invalid, etc.) comprising a person support component (e.g. a lifting and lowering element, a bed, a wheel chair, etc.), a support castor component and a steering control component for steering the system,

said support castor component comprising a first forward castor wheel assembly laterally spaced apart from a second forward wheel assembly, said first forward castor wheel assembly being forwardly spaced apart from a respective first rear wheel assembly, said second forward wheel assembly being forwardly spaced apart from a respective second rear castor wheel assembly, said first rear wheel assembly being laterally spaced apart from said second rear castor wheel assembly, each castor wheel assembly comprising a swivel wheel

and wherein said steering control component comprises a direction control element and a coupling element, said coupling element coupling said direction control element, said first forward castor wheel assembly and said second rear castor wheel assembly such that said first forward castor wheel assembly and said second rear castor wheel assembly define a single pair of steerable (i.e. coupled) castor wheel assemblies and such that a predetermined activation action (e.g. rotation, push button, etc . . . ) of the direction control element induces the swivel wheel of one of. the castor wheel assemblies of said single-pair of steerable castor wheel assemblies to swivel in one direction and induces a corresponding opposite swivelling of the swivel wheel of the other castor wheel assembly of said single pair of steerable castor wheel assemblies.

The wheel of each of the other wheel assemblies (i.e. the second forward wheel assembly and the first rear wheel assembly, referred to above,) may as desired or necessary be non-swivable or swivable as the case may be; advantageously these wheels are also swivable.

Thus in accordance with a particular aspect of the present invention, there is provided in a steerable mobile system (i.e. apparatus, combination, etc.) for the transportation of a person (e.g. patient, handicapped person, invalid, etc.) comprising a person support component (e.g. a lifting and lowering element, a bed, a wheel chair, etc.), a support castor component and a steering control component for steering the system

said support castor component comprising a first forward castor wheel assembly laterally spaced apart from a second forward castor wheel assembly, the first forward castor wheel assembly being forwardly spaced apart from a respective first rear castor wheel assembly, the second forward castor wheel assembly being forwardly spaced apart from a respective second rear castor wheel assembly, said first rear castor wheel assembly being laterally spaced apart from said second rear castor wheel assembly, each castor wheel assembly comprising a swivel wheel and

wherein a forward castor wheel assembly is coupled to a rear castor wheel assembly by coupling means such that the respective wheels thereof may be induced by said steering control component to simultaneously swivel in opposite directions about a respective vertical axis,

the improvement wherein the first forward castor wheel assembly is coupled by a coupling component to the second rear castor wheel assembly so as to define a single pair of steerable (i.e. coupled) castor wheel assemblies, wherein the second forward and first rear castor wheel assemblies are free swivelling castor wheel assemblies, and wherein said steering control component comprises a rotatable steering shaft element coupled by said coupling component to said single pair of steerable castor wheel assemblies such that rotation of the steering shaft element induces the wheel of the first forward castor wheel assembly of said single pair of steerable castor wheel assemblies to swivel in one direction and induces a corresponding opposite swivelling of the rear wheel of the second rear castor wheel assembly of said single pair of steerable castor wheel assemblies.

The swivelled castors may be coupled for simultaneous rotation in any suitable (known) manner; see for example U.S. Pat. Nos. 2,388,692 and 4,248,444 as well as other of the above mentioned patent documents. Thus the coupling element may comprises an endless flexible element (e.g. in the form of a flexible endless tensile member, of a belt, of a chain, etc.) coupling said direction control element, said forward castor wheel assembly and said second rear castor wheel assembly. On the other hand, the steerable wheels may be associated with non-mechanical means (e.g. electrical means) for inducing rotation; in this case the castor wheel assemblies may be associated with electric motors which are suitably connected in any (known) manner to the swivel wheels and to electrical rotation activation means, i.e. energisation of the electric motors. The electrical rotation activation means may comprise electrical swatches in the form of buttons , rotary switches, etc. connected to a suitable source of power e.g. an electric battery

In the drawing which illustrate an example embodiment(s) of the present invention:

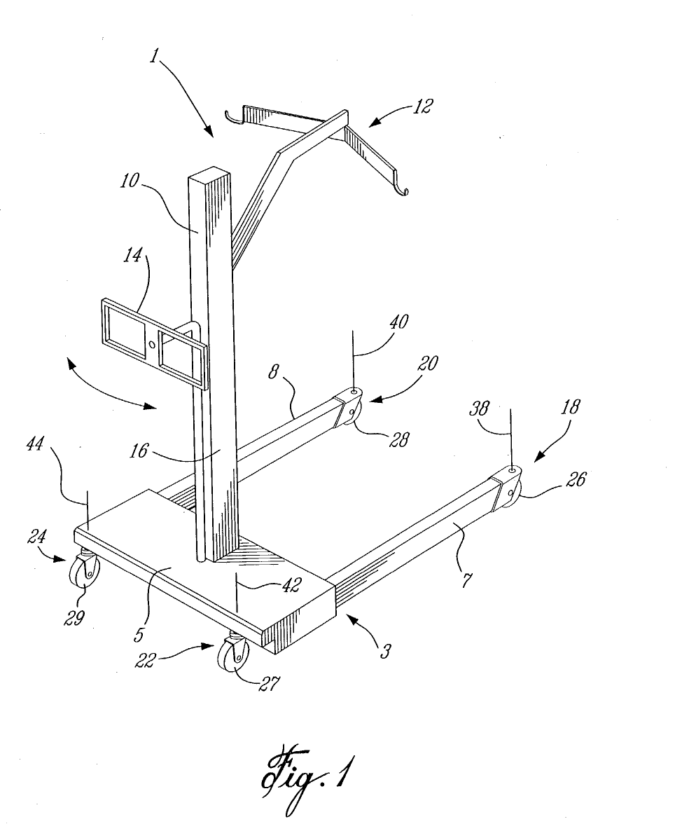

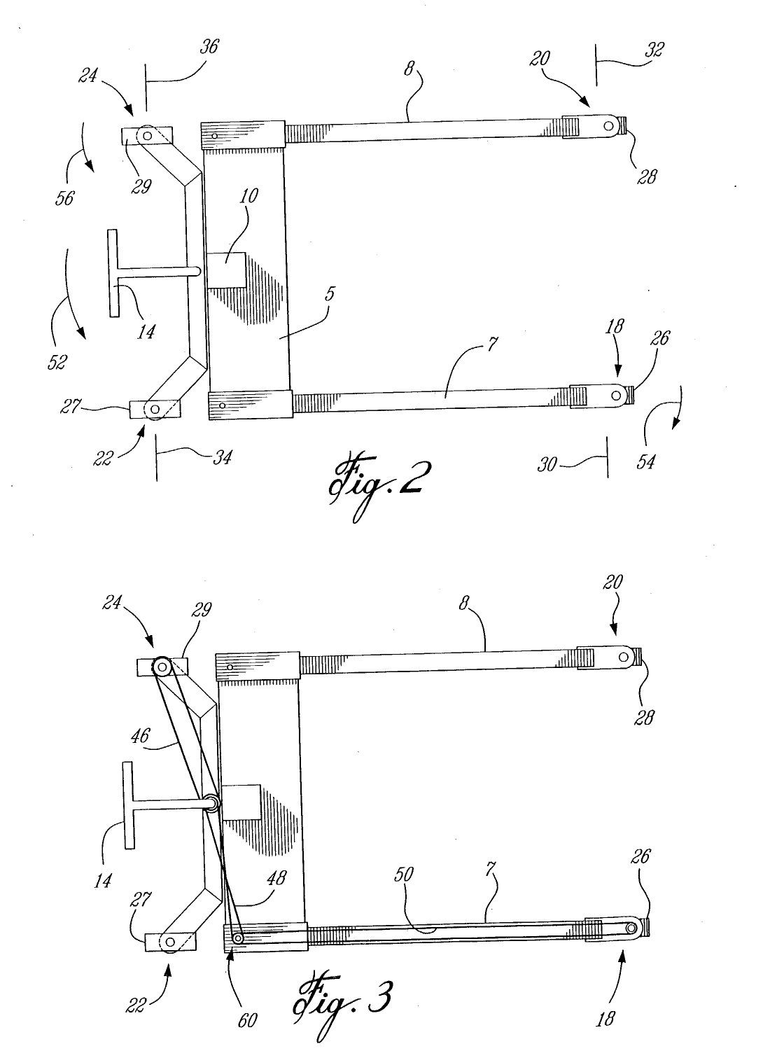

FIG. 1 is a schematic perspective view an example person (e.g. patient) handling device or apparatus of the present invention;

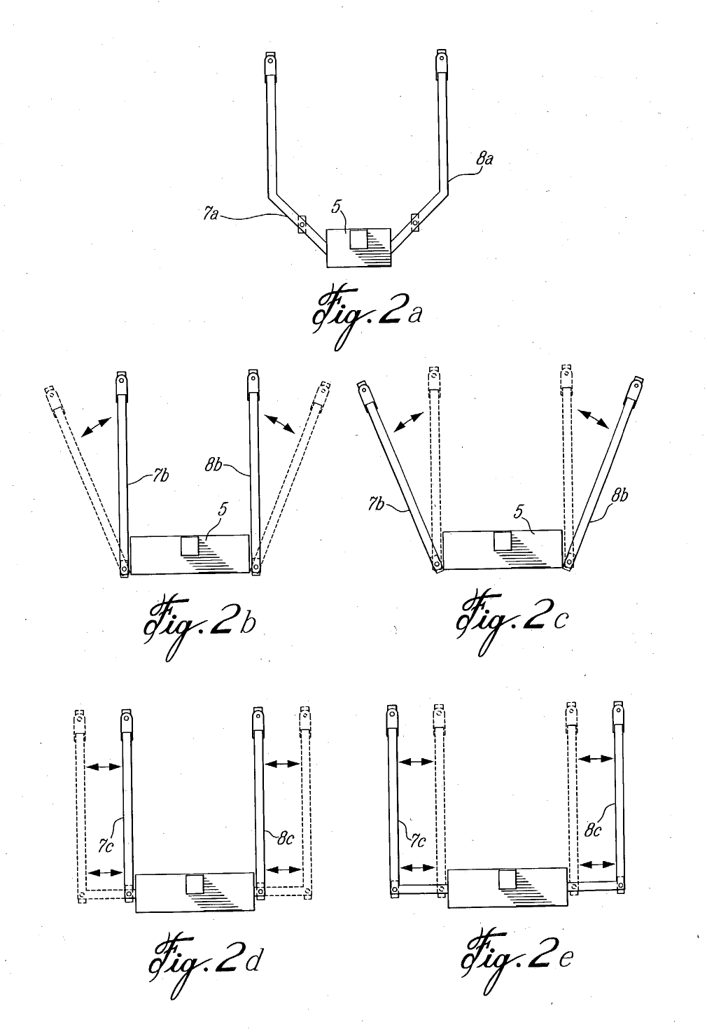

FIG. 2 is a schematic top view representation of the example person handling device of FIG. 1 but with an alternate example rear wheel(s) attachment structure, the person hoist member being removed for purposes of the illustration;

FIG. 2a is a schematic illustration of another example of a wheel assembly arrangement wherein the side pairs of wheels are disposed such that the axis passing through one side pair of wheels is disposed transverse to the same type of axis passing through the wheels of the other side pair of wheels (i.e. the side pairs of wheels are in a non-parallel type alignment with respect to each other);

FIGS. 2b and 2c schematically illustrate a further example of a wheel assembly arrangement wherein the side pairs of wheels are each engaged with a respective support arm, the sup port arms each being pivotally and lockably connected to a rear platform element;

FIGS. 2d and 2e schematically illustrate of an additional example of a wheel assembly arrangement wherein the side pairs of wheels are each engaged with a respective support arm, the support arms each being laterally telescopically and lockably connected to a rear platform element

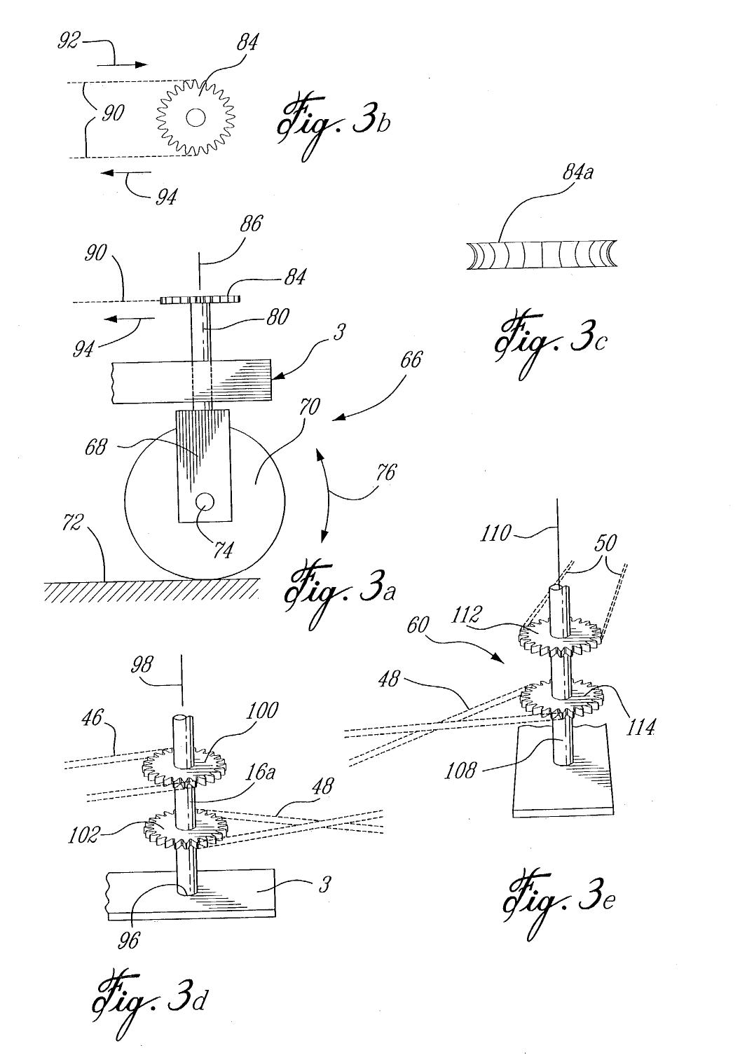

FIG. 3 is a schematic top view representation of the example person handling device of FIG. 2 showing a crisscrossed coupling mechanism between a single pair of steerable swivelled castors, the person hoist member being removed as well as the top part of the rear platform element for purposes of the illustration;

FIG. 3a is a schematic enlarged representation of an example steerable castor for coupling to a rotatable steering element of a steering control component;

FIG. 3b is a schematic top view representation of a drive wheel element of the steerable castor shown in FIG. 3a;

FIG. 3c is a schematic representation of an alternate form of a drive wheel element for incorporation in a steerable castor shown in 3b;

FIG. 3d is a schematic enlarged representation of an example rotatable steering element of a steering control means shown in FIG. 1;

FIG. 3e is a schematic enlarged representation of an example intermediate drive element for linking the front castor of the device shown in FIG. 1 to the rotatable steering element of a steering control means shown in FIG. 1;

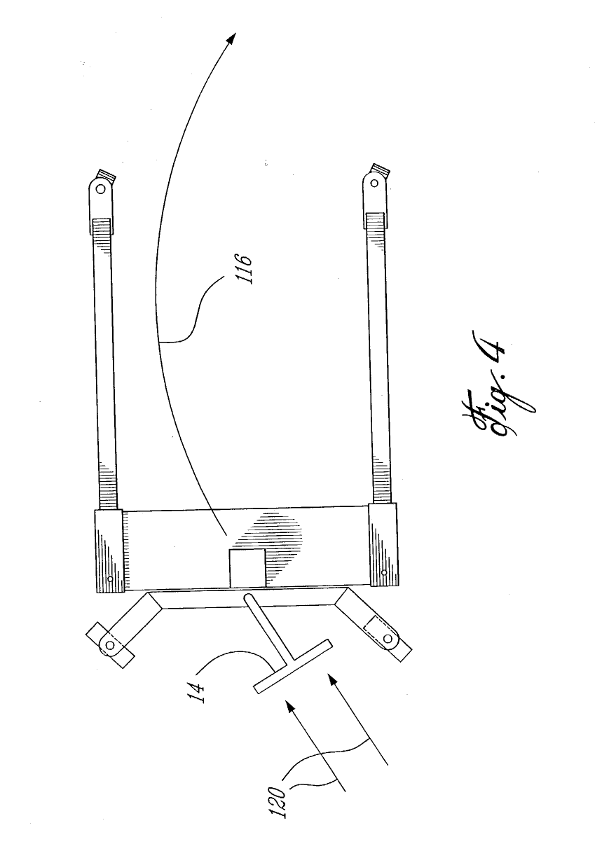

FIG. 4 is a schematic representation of the example person handling device of FIG. 1 wherein the steerable castors are oriented for a curved trajectory of the device, the person hoist member being removed as well as the top part of the rear platform element for purposes of the illustration; and

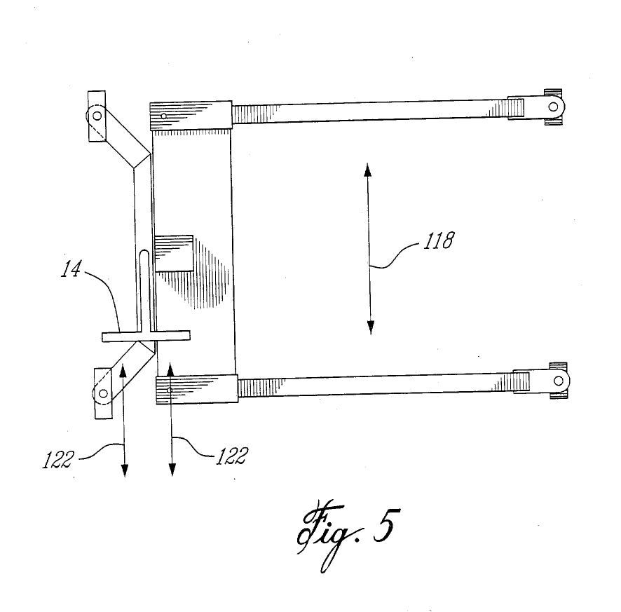

FIG. 5 is a schematic representation of the example person handling device of FIG. 1 wherein the steerable castors are oriented for a lateral trajectory of the device, the patient hoist member being removed as well as the top part of the rear platform element for purposes of the illustration.

Referring to FIGS. 1 and 2, figuret illustrates in schematic fashion an example steerable person handling apparatus reflecting the present invention, whereas FIG. 2 illustrates a modified variation of the apparatus of FIG. 1 with respect to the attachment of the rear wheels. The apparatus comprises patient support means indicated generally by the reference numeral 1. The apparatus comprises further comprises a U shaped base member indicated generally by the reference numeral 3. The base member 3 has a rear platform element 5. In the case of the example embodiment shown in FIG. 1 the rear wheels are attached directly to the rear platform element 5 whereas for the modified embodiment of FIG. 2 the rear wheels are indirectly attached to the rear platform element 5 by an intermediate structure; the remaining elements of the embodiments being the same such the same reference numerals are used with respect thereto. Thus each embodiment has two elongated spaced apart support arm members 7 and 8 which extend from the rear platform element 5 so as to give the base member a U-like shape. For the example embodiments shown the arm members 7 and 8 are disposed such that the longitudinal axis passing through each of the respective pair of wheels thereof are more or less parallel to each other. The arm members 7 and 8 are also fixed to the rear platform element 5.

Referring to FIGS. 2a thru 2e, these figures illustrate in schematic fashion, alternate examples of wheel attachment arrangements; the wheels are denoted by a plus sign within a circle. FIG. 2a is a schematic illustration of example of a wheel assembly arrangement wherein the wheels of each side pairs of wheels are attached to an arm member (7a and 8a) so as to be disposed such that the axis passing through one side pair of wheels is disposed transverse to the same type of axis passing through the wheels of the other side pair of wheels (i.e. the side pairs of wheels are in a non-parallel type alignment with respect to each other). FIGS. 2b and 2c schematically illustrate of a further example of a wheel assembly arrangement wherein the wheels of each side pairs of wheels are attached to an arm member (7b and 8b), each of which is suitably journaled to the rear platform element such that each support arms each is pivotally and lockably connected at the rear end thereof to the rear platform element. Thus for example the pivot connection may comprise an axle pin member (e.g. nut/bolt combination) and a axle sleeve member. For each of the axle pin members the rear platform element may comprise a pair of spaced apart projections (i.e. elements of a U-shaped yolk member) which have holes therein for receiving the elongated portion a bolt. The rear end of each of the support arms 7b and 8b may comprise an axle sleeve member configured for rotational disposal between the spaced apart projections and for rotationally seating or engaging the elongated portion of the bolt. The bolt may maintain the support arm in place (i.e. attached to the rear platform element) on the one hand by the bolt head and at the other end of the bolt by a nut. In this manner a support arm may be rotationally or pivotally displaced between positions shown in FIGS. 2b and 2c (i.e. in the direction of the arrows). The support arms may be locked in a predetermined position by any suitable means such as for example a lock screw able to be threaded thru a lock screw opening in the side of the sleeve allowing the lock screw to be screwed up against and engage the elongated portion the bolt. Any other type of lock/rotation mechanism may of course be used.

FIGS. 2d and 2e schematically illustrate an additional example of a wheel assembly arrangement wherein the side pairs of wheels are each engaged with a respective support arm, the support arms each being laterally telescopically and lockably connected to a rear platform element (i.e. for displacement in the direction of the arrows); the telescopic arrangement may take on any suitable or desired configuration; as shown the rear platform element has sleeve members for slidably engagement of extension members attached to the ends of support arms 7c and 8c which may be lockable in place by a suitable pin able to pass transversely thru the sleeve member and the extension member.

Referring back to FIGS. 1 and 2, an upright post or mast member 10 is attached to the rear platform element 5. The mast member 10 is provided with a patient support or hoist mechanism, indicated generally by the reference numeral 12; the person hoist member 12 may, however, take on any (known) desired or required configuration; see for example the above mentioned U.S. patents. The person handling apparatus has a steering control means which comprises a steering handle 14 which is connected to a rotatable steering element (i.e. a rotatable shaft 16) the rotatable shaft 16 is journaled at a lower end thereof to the rear platform element 5 in any suitable which allows for its rotation about its longitudinal axis.

Referring to FIGS. 1 and 2 the base member 3 is supported on a support castor component; the castor component comprises a plurality of castor wheel assemblies mounted to the base member 3 and arranged to support the base member 3 on a floor or the like on which the mobile support unit rests. As may be seen, the castor component has two laterally spaced apart side pairs of castor wheel assemblies. One side pair of castor wheel assemblies comprises a respective front or forward (i.e. first) wheel castor assembly 18 and a respective first rear wheel castor assembly 22. The other side pair of castor wheel assemblies comprises a respective front or forward (i.e. second) wheel castor assembly 20 and a respective second rear wheel castor assembly 24. As may be seen each front wheel castor assembly is forwardly spaced apart from a respective rear wheel castor assembly on the same side of the apparatus.

Each of the castor wheel assemblies comprises a wheel 26, 27, 28 and 29 respectively (i.e. for rolling engagement with a support surface such as a floor, ground etc . . . ). Each of the castor wheel assemblies, may also comprise any suitable (known) means (e.g. an axle member) f6r supporting its respective wheel

for rotation about a substantially horizontal rotational (i.e. rolling) axis (indicated respectively in FIG. 2 generally by the reference numerals 30, 32, 34 and 36) and

for swivelling movement about a substantially vertical swivelling axis (indicated respectively in FIG. 1 generally by the reference numerals 38, 40, 42 and 44).

Known attachment and support mechanisms for rotation of a wheel about a substantially horizontal rolling axis and for swivelling movement of the wheel about a substantially vertical swivelling axis may for example be gleaned from U.S. Pat. Nos. 2,388,692, 4,248,444, 4,934,726 and 4,4950,126 as well as Canadian patent application no. 2,093,121 (the entire contents of each of these documents is incorporated herein by reference).

Referring to FIG. 3 a single pair of the castor wheel assemblies are coupled together for mutual rotation of their respective wheels about a respective swivel axis; the single pair of castor wheel assemblies comprises front castor wheel assembly 18 and rear castor wheel assembly 24. As may be seen the front or forward castor wheel assembly 18 is located on one side of the apparatus whereas the rear castor wheel assembly 24, to which front castor wheel assembly 18 is coupled, is located on the other (i.e. opposite) side of the apparatus. The remaining front or forward castor wheel assembly 20 and the rear castor wheel assembly 22 are free swivelling castor assemblies i.e. these castor wheel assemblies are not coupled to other castor wheel assemblies,( e.g. they are not coupled together for steering purposes). Although for the purposes of this illustrated example embodiment of the invention, the front or forward castor wheel assembly 20 and the rear castor wheel assembly 22 are swivable these wheel assemblies may if so desired or necessary be relaced by non-swivable wheel assemblies, i.e. by wheel assemblies providing only a wheel rolling function. In this latter case turning would still be facilitated but would necessitate an increased application of force to rotationally overcome frictional enagement of the non-swivable wheels engaging the rolling surface. On the other hand a straight lateral displacement would be frictionally impeded by these non-swivable wheels. Accordingly, it is more advantageous to have an apparatus or system wherein all of the wheels be swivable

The front castor wheel assembly 18 and the rear castor wheel assembly 24 are coupled together by a plurality of endless flexible tensile members, (i.e. loop or belt members) designated by the reference numerals 46, 48 and 50 for simultaneous opposite rotation of wheels 26 and 29 about respective swivel axii 38 and 44. Referring to FIG. 2 the coupling is such that turning the handle 14 in the direction of the arrow 52 will induce the wheel 26 to swivel in the direction of the arrow 54 while at the same time inducing the wheel 29 to swivel in the direction of the arrow 56. Loop member 48 couples the steering element 16 to an intermediate drive assembly indicated generally by the reference numeral 60. As may be seen loop member 48 is crisscrossed for the inducing of simultaneous opposite rotation about said axis of the wheels 26 and 29. The coupling may for example be effected by a flexible polymeric belt system, a chain gear means or the like.

The front castor wheel assembly 18 and the rear castor wheel assembly 24 each include a respective drive wheel element (e.g. in the form of a sprocket wheel, friction wheel, or the like) engaged by an associated loop member(s) for transferring angular or rotational motion of the steering element to these castor wheel assemblies i.e. for controlling or inducing rotation of the castor wheels about the respective vertical axis thereof.

FIGS. 3a and 3b illustrate in schematic fashion an example castor wheel assembly construction having a drive wheel element; i.e. the front castor wheel assembly 18 and the rear castor wheel assembly 24 may each have this type of structure. The castor wheel assembly has a yoke member 68 which is generally U-shaped element. A wheel 70 (e.g. for engagement with a floor or ground 72) is mounted to the yoke member 68 between the arms of the U-shaped yoke member 68 by an axle 74. The axle 74 spans the distance between the arms of the U-shaped yoke such that the wheel 70 may rotate about the axle 74 in the directions of the arrow designated by the reference numeral 76, i.e. rotate about the rolling axis which passes through the axle 74. The yoke member 68 has an upwardly extending swivel pin (or swivel shaft) 80 which is rotationally mounted to the base member 3 in any (known) suitable fashion such that the wheel may swivel about the swivel axis 86.

The swivel shaft 80 is fixed at one end thereof to the yoke member 68 and at the other end thereof to a drive wheel element 84. The yoke member 68 and the swivel shaft 80 are mounted in any suitable manner to the base member 3 such that rotation of the swivel shaft 80 about the swivel axis 86, induced via the drive wheel element 84, will induce a corresponding rotation of the wheel 70 about the swivel axis 86; e.g. the swivel shaft 80 may extend through an opening in the base member 3 sized to facilitate rotation of shaft 80 therein. The rotation about the swivel axis 86 may for example eb induced by the loop member 90 being pulled or travelling in the directions designated by the arrows 92 and 94 (or in opposite direcctions).

The drive wheel element 84 may take any desired form; it may for example be sprocket wheel (see FIG. 3b) in which case a flexible tensile member may be a loop defined by a chain; it may alternatively for example be a grooved wheel 84a (see FIG. 3c) in which case the tensile member may be a loop defined by a chain or a belt (i.e. a belt made of a flexible plastics material).

Referring back to FIG. 3, rotation of the swivel shaft of the rear castor wheel assembly 24 is induced by a direct coupling, effected by the loop member 46, between the drive wheel element thereof and the rotatable shaft 16.

The steering control-means for the apparatus may comprise a rotatable shaft portion 16a such as is schematically set forth in FIG. 3d; the shaft portion 16a may be an extension of shaft 16 shown in FIG. 1. The rotatable shaft 16a as shown may be a shaft which is journaled at one end 96 thereof to the base member 3 in any suitable (known) manner allowing the shaft 16a to be able to be rotated about its longitudinal axis 98. Two wheel-type drive elements 100 and 102 are fixed to the shaft 16a such that rotation of the shaft 16a about its longitudinal axis 98 causes these drive elements to rotate in like manner about this axis 98. The drive elements 100 and 102 may, for example, take on a form the same as the above mentioned drive wheel 84; i.e. the drive elements 100 and 102 may have a form such as sprocket wheel, a grooved wheel etc . . . ).

Referring back to FIG. 3, rotation of the swivel shaft for the front castor wheel assembly 18 is induced indirectly from the rotatable shaft 16 by the loop members 48 and 50 as well as by the intermediate drive assembly 60.

Referring to FIG. 3e the intermediate drive assembly 60 may have a form analogous to that of the rotatable shaft 16a in that it also has a rotatable shaft 108 which is journaled to the base member 3 to rotate about its longitudinal axis 110 and it has fixed thereto two wheel-type drive elements 112 and 114 which make take the above described forms mentioned with respect to drive wheel element 84 (e.g. a sprocket wheel); the two wheel-type drive elements 112 and 114 as shown are respectively engaged by the loop members 48 and 50.

Referring to FIGS. 4 and 5, the opposed (i.e. crisscross) castor coupling permits the patient support unit to be relatively easily guided by the handle 14 for being manually swung through an arc 116 or to be displaced laterally (arrow 118) when a specified force is for example manually applied to the support unit (in the respective direction and position of the arrows 120 and 122 respectively) to position the support unit as desired; e.g. displacement resistance is relatively low even with a patient being displaced by the unit.

We claim:

1. A steerable mobile system (i.e. apparatus, combination, etc.) for the transportation of a person (e,g. patient, handicapped person, invalid, etc.) comprising a person support component (e.g. a lifting and lowering element, a bed, a wheel chair, etc.), a support castor component and a steering control component for steering the system,
said support castor component comprising a first forward castor wheel assembly laterally spaced apart from a second forward wheel assembly, said first forward castor wheel assembly being forwardly spaced apart from a respective first rear wheel assembly, said second forward wheel assembly being forwardly spaced apart from a respective second rear castor wheel assembly, said first rear wheel assembly being laterally spaced apart from said second rear castor wheel assembly, each castor wheel assembly comprising a swivel wheel
and wherein said steering control component comprises a direction control element and a coupling element, said coupling element coupling said direction control element, said first forward castor wheel assembly and said second rear castor wheel assembly such that said forward castor wheel assembly and said second rear castor wheel assembly define a single pair of steerable (i.e. coupled) castor wheel assemblies and such that a predetermined activation action (e.g. rotation, push button, etc . . . ) of the direction control element induces the swivel wheel of one of the castor wheel assemblies of said single pair of steerable castor wheel assemblies to swivel in one direction and induces a corresponding opposite swivelling of the swivel wheel of the other castor wheel assembly of said single pair of steerable castor wheel assemblies.

2. A steerable mobile system as defined in claim 1 wherein said coupling element comprises an endless flexible element (e.g. in the form of a flexible endless tensile member, of a belt, of a chain, etc.) coupling said direction control element, said first forward castor wheel assembly and said second rear castor wheel assembly.

3. In a steerable mobile system (i.e. apparatus, combination, etc.) for the transportation of a person (e.g. patient, handicapped person, invalid, etc.) comprising a person support component (e.g. a lifting and lowering element, a bed, a wheel chair, etc.), a support castor component and a steering control component for steering the system said support castor component comprising a first forward castor wheel assembly laterally spaced apart from a second forward castor wheel assembly, the first forward castor wheel assembly being forwardly spaced apart from a respective first rear castor wheel assembly, the second forward castor wheel assembly being forwardly spaced apart from a respective second rear castor wheel assembly, said first rear castor wheel assembly being laterally spaced apart from said second rear castor wheel assembly, each castor wheel assembly comprising a swivel wheel
and
wherein a forward castor wheel assembly is coupled to a rear castor wheel assembly by coupling means such that the respective wheels thereof may be induced by said steering control component to simultaneously swivel in opposite directions about a respective vertical axis,
the improvement wherein the first forward castor wheel assembly is coupled by a coupling component to the second rear castor wheel assembly so as to define a single pair of steerable (i.e. coupled) castor wheel assemblies, wherein the second forward and first rear castor wheel assemblies are free swivelling castor wheel assemblies, and wherein said steering control component comprises a rotatable steering shaft element coupled by said coupling component to said single pair of steerable castor wheel assemblies such that rotation of the steering shaft element induces the wheel of the first forward castor wheel assembly of said single pair of steerable castor wheel assemblies to swivel in one direction and induces a corresponding opposite swivelling of the second rear wheel of the second rear castor wheel assembly of said single pair of steerable castor wheel assemblies.

4. A steerable mobile system as defined in claim 3 wherein said coupling component comprises an endless flexible element (e.g. in the form of a flexible endless tensile member, of a belt, of a chain, etc.) coupling said direction control element, said first forward castor wheel assembly and said second rear castor wheel assembly.
